(19) United States
(12) Patent Application Publication
(10) Pub. No.: US 2007/0168110 A1
(43) Pub. Date: Jul. 19, 2007

(54) Integrated access of road-based traffic control information with geographic location data

(76) Inventors: Hai Dong Jiang, Beijing (CN); Ya Ping Ren, Beijing (CN); Ranjan Sharma, New Albany, OH (US); Shengqiang Wang, Raleigh, NC (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/390,771

(22) Filed: Mar. 28, 2006

(30) Foreign Application Priority Data
Jan. 13, 2006 (CN) 200610008996.6

(51) Int. Cl. G08G 1/00

(52) U.S. Cl. 701/117

(57) ABSTRACT

An exemplary method provides-base traffic control (rbtc) information. A network node receives a request generated by a user's electronic device for the rbtc information, where the request includes location data. The network node determines a roadway associated with the location data. A database is queried for rbtc information relevent to the roadway and a position on the roadway associated with the location data. A reply is received to the query where the reply contains relevant rbtc information. The relevant rbtc information is transmitted from the network node to the user's device.

### BACKGROUND

This invention relates to acquiring and utilizing geographic location information and more specifically to determining information relevant to automobile drivers, e.g. posted speed limits, at locations along roadways.

Portable electronic devices that display a user's current geographic location are readily available. Such devices typically derive geographic location based on latitude and longitude determined from signals received from the system of global positioning satellites (GPS). In order to make this information easier to interpret by users, many such devices display a map showing the location of the device relative to roads and other significant geographic points such as railroad tracks, bodies of water, mountains, etc. The map information is typically stored in memory in the electronic device with updates provided by a service provider of such geographic information to which the user subscribes. For example, a common use of such electronic devices is by an automobile driver who uses the current location of the vehicle as displayed on a map of roadways to determine a current location as well as ascertaining directions to reach a final destination. Although these devices have proved to be very helpful to automobile drivers, there exists a need to provide additional road-based traffic control information such as to drivers as they proceed to a destination.

### SUMMARY

It is an object of the present invention to satisfy this need.

An exemplary method provides road-based traffic control (rbtc) information. A network node receives a request generated by a user's electronic device for the rbtc information, where the request includes location data. The network node determines a roadway associated with the location data. A database is queried for rbtc information relevant to the roadway and a position on the roadway associated with the location data. A reply is received to the query where the reply contains relevant rbtc information. The relevant rbtc information is transmitted from the network node to the user's device.

### DESCRIPTION OF THE DRAWINGS

Features of exemplary implementations of the invention will become apparent from the description, the claims, and the accompanying drawings in which:

FIG. 1 is a block diagram of a network suited for incorporation of an embodiment of the present invention.

FIG. 2 is a flow diagram of steps for providing road-based traffic control information in accordance with an embodiment of the present invention.

### DETAILED DESCRIPTION

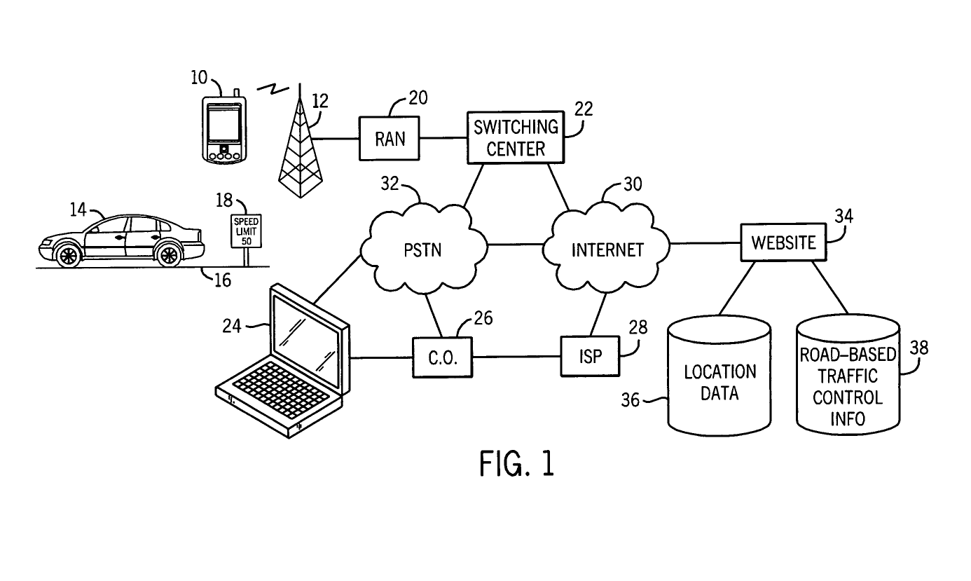

FIG. 1 shows a diagram suited for incorporation of an embodiment of the present invention. An electronic device 10 is utilized to display location information to a user and in the illustrative example is capable of wireless communications, itself or indirectly via a transceiver coupled to it, with a base station 12. The electronic device 10 will typically contain a GPS receiver and computational capabilities for processing the received GPS signals to ascertain a current location in terms of latitude and longitude. It will also contain a screen for displaying location related information such as an electronic image of a map of an area that includes the location of the device. It will be apparent that electronic device 10 may consist of a stand-alone portable device, a device mounted or attached to a vehicle, or implemented as part of another electronic device such as a cellular telephone, personal digital assistant or laptop computer.

In a typical scenario the portable electronic device 10 may be utilized by the driver of vehicle 14 traveling along roadway 16 to determine the current location of the vehicle as well as ascertaining directions to reach a destination based on landmarks, roads and other information provided on the displayed map. In accordance with an embodiment of the present invention, various types of road-based traffic control information is provided to the driver, e.g. the posted speed limit along a segment of the roadway. As used herein, road-based traffic control information refers to visually presented information normally conveyed to a driver by signs or signaling devices visible to a driver on the roadway. For example, a speed limit sign 18 indicating “Speed Limit 50” is posted along roadway 16. Other types of indicia conveying road-based traffic control information includes, but is not limited to, signs advising motorists of upcoming curves, lane changes and/or mergers, right-of-way information, railroad track crossings, etc. as well as electronically conveyed information such as stop and go traffic light signals and electronic character or symbol based boards that display or scroll information relevant to a driver such as road construction ahead, lane or road closures, and parking availability. As used herein, temporary road-based traffic control information refers to rbtc information that is temporarily different than normal applicable rbtc information. For example, temporary rbtc information includes, but is not limited to, a temporarily changed speed limit such as in a temporary roadway construction zone, or a stop sign placed at an intersection during a malfunction of a stop and go traffic light that normally controls the flow of traffic at the intersection.

Wireless communications between electronic device 10 and base station 12 are supported by the radio access node (RAN) 20 and switching center 22. The specific apparatus implementing RAN 20 and switching center 22 will be determined by the specific telecommunication architecture and signaling method deployed.

A laptop computer 24 is equipped with GPS signal receiving capabilities and includes software and/or hardware adapted for displaying location information including maps on its screen. In the illustrative example it is connected by a wireline to a central switching office 26 that supports communications by an Internet service provider (ISP) 28 with Internet 30. It will be noted that the mode of connection of laptop computer 24 for communications could be any type, i.e. wired or wireless. Communications are also supported with the public switched telephone network (PSTN) 32. A web site 34, coupled to Internet 30, supports an application program that supplies location information stored in database 36 as well as road-based traffic control information stored in database 38 to subscribers. It will be apparent to those skilled in the art that all the information could be contained in a single database if desired as well as integrating elements 34, 36 and 38 into a single apparatus. The web site may comprise a computer having a microprocessor supported by read only memory, random access memory, non-volatile memory such as a hard drive, user input/output interfaces, and communication input/output interface for internet based communications. It operates under the control of an operating system and one or more suitable application programs.

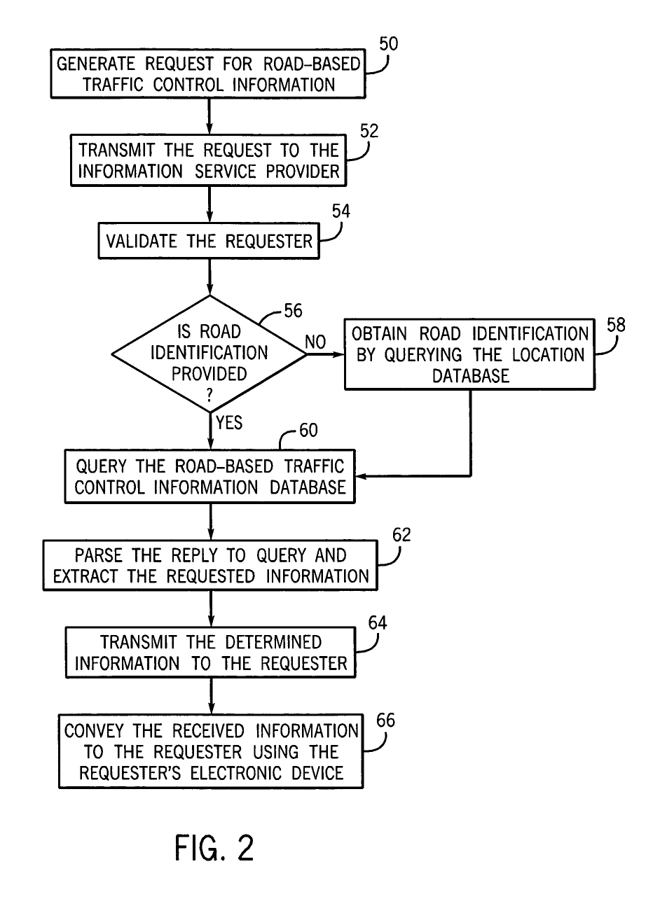

FIG. 2 shows exemplary steps for determining and providing road-based traffic control information to a user. In this illustrative example, a driver of vehicle 14 is utilizing a portable electronic device 10 to obtain location information. The driver desires to obtain any available road-based traffic control information currently available. In accordance with step 50, the user causes a request for road-base traffic control information to be generated by device 10. The request will contain an address or some form of identification to permit the user to be identified by the service provider and receive a reply message. The identification may consist of a user's personal identification number or an electronic serial number associated with the user's electronic device. The request will also specify the current location of the user such as by the current latitude and longitude as determined by processing the GPS signals by the electronic device. The request may, but need not, also contain identification of the road 16 on which the vehicle 14 is currently traveling. The current road information may be stored in the electronic device based on information previously received from the service provider or may be manually input or specified by the user. The request may further specify a particular type of road-based traffic control information desired by the user. For example, the driver may desire to know the current speed limit or if a dangerous condition warning is in effect for an upcoming segment of roadway (high wind conditions along an overpass or icing conditions on an upcoming bridge). Predetermined commands known to both the electronic device 10 and the remote web site/database(s) can be used to specify corresponding road-based traffic control information.

In step 52 the request for information is transmitted from the electronic device of the driver to the service provider. The address, e.g. a domain address or IP address, of the service provider can be programmed into and stored in the electronic device 10. In this example, the request is transmitted by base station 12, RAN 20, switching center 22 and Internet 30 to the web site 34 operated by the provider of location information. In step 54 the application running on web site 34 authenticates the received request as originated by a valid subscriber. In step 56 a determination is made of whether the request contains road identification information. A NO determination by step 56 results in the web site 34 utilizing the current latitude and longitude of the user as received in the request to query the location database 36. The location database 36 contains geographic information relating to the position of roadways so that a particular roadway or street can be identified based on the specified latitude and longitude. Based on this query, the location database 36 returns the identification of the current roadway on which the user is traveling. Or alternatively, transmits information indicating that no known roadway corresponds to the query.

On a YES determination by step 56 or upon completion of step 58, the web site 34 queries the road-based traffic control information database 38 to determine traffic control information related to the identified roadway and the location of the user on this roadway. In step 62 the web site 34 parses the reply to the query from database 38 and extracts the requested traffic control information. The requested traffic control information may consist of a particular parameter, e.g. speed limit, specified by the user or may comprise a general query in which all road-based traffic control information relevant to the proximity of the user is selected to be transmitted to the user. In step 64 the selected information is transmitted from web site 34 to the user's electronic device 10 generally over the same path traversed by the request. It will be apparent to those skilled of the art that the particular path by which the information is transmitted need not be the same path utilized to receive the request.

In step 66 the selected information is received by the user's device 10 which processes the information and conveys it to the user. The information may be conveyed to the user by displaying alphanumeric characters on the screen of the display, displaying symbols or indicia representing the information or by utilizing an audible output such as by verbalizing a received text message utilizing a text-to-speech converter.

If rbtc information is displayed on the device used in a vehicle for the next 10 miles along the currently traveled route, a sample output could look like:

Mile 2: road contruction begins for the next 4 miles

Mile 7: left lane closure

Mile 9: rest area

Mile 10: slippery road

It will be aparent that this information could be either listed on the screen or individual items could be displayed adjacent to the location of the item on a map of the roadway.

Although an exemplary implementation of the invention has been depicted and described in detail herein, it will be apparent to those skilled in the art that various modifications, additions, substitutions, and the like can be made without departing from the spirit of the invention. For example, a request may be originated by a user where the electronic device utilized by the user is not currently in the location for which the information is desired. That is, a user may employ laptop computer 24 to generate a request for road-based traffic control information for informational purposes in planning a future journey. In such a situation the request generated by the user must specify at least a latitude and longitude location or a specific location on a roadway for which the request is sought. This can be accomplished by manually inputting the information by the user or by specifying a particular point on a displayed map such as by utilizing a pointing device. This permits user to obtain road-based traffic control information without having to be at a location on the roadway for which such information is sought. It may also be desirable to automatically update the user with a particular type or category of traffic control information. For example, a driver may desire to be continually updated with regard to heavy traffic flow (congestion causing slow travel) or closed road conditions within a predetermined distance of the current location of the driver's vehicle along an intended route. In this case, the user's device 10 may periodically generate such requests for traffic control information.

The road-based traffic control information transmitted to the user device 10 can be kept current by periodically downloading updates from a centralized service provider. In addition to responding to demand based queries from device 10, the application running on the rbtc information website can automatically generate and transmit periodic updates such as every 5 minutes. Such updates can be suspended for devices located in a vehicle when the vehicle position has not significantly changed since the last update. Asynchronous, event-based updates are also possible. For example, if the indications associated with a previously stored route change, the server may update the requesting devices on its own. Such updates can account for change in traffic pattern, lane closures, construction-related temporary speed restrictions, temporary rbtc information, and such.

The scope of the invention is defined in the following claims.

1. A method for providing road-based traffic control (rbtc) information comprising the steps of:
receiving at a network node a request generated by a user's electronic device for the rbtc information, where the request includes location data;
determining at the network node a roadway associated with the location data;
querying a database for rbtc information relevant to the roadway and a position on the roadway associated with the location data;
receiving a reply to the query where the reply contains relevant rbtc information;
transmitting the relevant rbtc information from the network node to the user's device;
wherein the step of transmitting comprises transmitting a speed limit of the roadway at the position.

2. The method of claim 1 wherein the step of receiving the request comprises receiving the request generated by a user's wireless electronic device.

3. The method of claim 1 wherein the step of determining comprises parsing the request to identify roadway information transmitted from the user's electronic device.

4. The method of claim 1 wherein the step of determining comprises transmitting a query containing the location data to a database containing roadway information that can be accessed based on location data, and receiving a reply in response to the query where the reply contains an identified roadway corresponding to the location data.

5-6. (canceled)

7. The method of claim 1 wherein the network node comprises a web site and the user's electronic device comprises a wireless electronic device, communications between the wireless electronic device and the network node being supported by a communication system.

8. The method of claim 1 wherein the user's electronic device is a wireless electronic device disposed in a vehicle traveling along the roadway.

9-11. (canceled)

12. The method of claim 1 wherein said speed limit of the roadway is a posted speed limit.

13-14. (canceled)
